(19) United States
(12) Patent Application Publication
(10) Pub. No.: US 2026/0065894 A1
(43) Pub. Date: Mar. 5, 2026

(54) TEXT-TO-VOICE MODULE AT A PERIPHERAL DISPLAY PORT WITH COMMUNICATION PROTOCOL DETECTION

(71) Applicant: Dell Products L.P., Round Rock, TX (US)

(72) Inventors: Ghee Beng Ooi, Singapore (SG); Fong Tien Chee, Singapore (SG); Yu Weng Alvin Sitoh, Singapore (SG)

(73) Assignee: Dell Products L.P., Round Rock, TX (US)

(21) Appl. No.: 18/825,132

(22) Filed: Sep. 5, 2024

(51) Int. Cl. G10L 13/08; G06F 13/40

(52) U.S. Cl. CPC G10L 13/08; G06F 13/40

(57) ABSTRACT

A peripheral display supports audible voice commands that describe operational states to aid in use of the peripheral display by a disabled person with a dongle that receives strings of text for translation to voice that is played at a speaker. The dongle couples with a USB connector to a USB port of the peripheral display with one ground pin of the port and connector having opposing pull-up and pull-down resistors so that a high signal at the ground pin selects a mux to communicate text data and a low signal selects the mux to communicate USB data. The text data includes UART text strings with flexibility to use I2C communications for firmware updates and other data and command transfer applications.

### BACKGROUND OF THE INVENTION

### Field of the Invention

The present invention relates in general to the field of information handling system peripheral displays, and more particularly to an information handling system text-to-voice module at a peripheral display port with communication protocol detection.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems integrate processing components that cooperate to process information, such as a central processing unit (CPU) that executes instructions to process information and a random access memory that stores the instructions and information. Desktop and other types of stationary systems have stationary housings that interface with peripheral devices to support end user interactions, such a peripheral display, peripheral keyboard and peripheral mouse. Portable information handling systems are built in a portable housing that includes an integrated display, keyboard and power source to support mobile operations. Portable information handling systems allow end users to carry a system between meetings, during travel, and between home and office locations so that an end user has access to processing capabilities while mobile. When an end user is in an office location, portable information handling systems will also typically interact with peripheral devices to support end user interactions. In particular, peripheral displays are helpful to end users by offering larger display areas than can typically be found in an integrated display.

End user interactions with information handling systems face challenges when end user disabilities inhibit the end user's ability to understand how to operate peripheral devices. In 2010, the Twenty-First Century Communications and Video Accessibility Act (CVAA) mandated updated requirements for ensuring the accessibility of modern telecommunications to people with disabilities. CVAA compliance for peripheral displays can include audible instructions for peripheral display operation even when not connected to an information handling system. Including hardware in a peripheral display to support this requirement results in increased costs even though the audible instructions are used by a relatively few number of disabled individuals. As an example, the DELL U4021QW and P2722H peripheral displays support text-to-speech with a separate CVAA board added in the peripheral display and coupled to the display interface board to interact with a scalar coupled to the interface board. When an end user desires disability support, the peripheral display is equipped with the CVAA board at an increased cost. Although this approach avoids including hardware in all peripheral displays to support text-to-speech functionality, the additional hardware, logic and expense is typically tracked as separate product SKUs that increase the complexity of managing product distribution to end users. Another option is to couple a dongle to a port of the peripheral display when audible instructions are desired, such as a Universal Serial Bus (USB) port. This approach reduces cost across for the peripheral display by moving costly logical components to the dongle to support USB communication.

### SUMMARY OF THE INVENTION

Therefore, a need has arisen for a system and method which enables text-to-speech functionality at peripheral displays with a universal display architecture that supports a text-to-speech dongle insertion at a display port.

In accordance with the present invention, a system and method are provided which substantially reduce the disadvantages and problems associated with previous methods and systems of supporting text-to-speech support at a peripheral display. A text-to-speech dongle connects to a peripheral display port and is identified with opposing pull-up and pull-down resistors so that a scalar of a peripheral display communicates text-formatted information to the dongle for presentation as speech.

More specifically, an information handling system processes information with a processor that executes instructions in cooperation with a memory and presents the information as visual images at a peripheral display. The peripheral display has a port that selectively configures to communicate with a standard data format, such as USB-formatted information, or with text-formatted information, such as UART text strings.

The selection of the communication format is automatically performed by opposing pull-up and pull-down resistors that send a high or low signal to a mux selector. Text strings are played as voice statements to support CVAA requirements.

The present invention provides a number of important technical advantages. One example of an important technical advantage is that a peripheral display port supports a dual purpose with USB-formatted and text-formatted information depending on the type of device connected to the port. USB dual purpose with UART text strings is supported consistent with the USB-IF specification by using one of the USB grounds to interface pull-up and pull-down resistors. CVAA voice operational information is provided with fluent speech through UART text strings. CVAA voice messages are output at connection of the text-to-speech dongle to the peripheral display to inform an end user of voice support and at power down of the peripheral display before power is turned off. The dongle operates to output audible information without any other external connections, such as to output error messages that “No cable is detected” or “Power off” when a power button is pressed. Other types of voice information can include the lack of a display source or the active display source selected. USB, UART and I2C communications are supported from the same port with automated detection of the type of connector inserted in the port.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system interfaced with a peripheral display configured to play operational conditions as audible voice from text strings with a text-to-voice dongle;

FIG. 2 depicts a block diagram of an example embodiment of a peripheral display interface board that selectively communicates text formatted information and USB formatted information at a USB port;

FIGS. 3A and 3B depict a circuit block diagram of communication of CVAA text strings from the scalar to the text-to-speech dongle;

FIG. 4 depicts a circuit block diagram of one example embodiment of mux communications to support a selected of UART text-formatted information or USB-formatted information; and

FIG. 5 depicts a flow diagram of a process for selection of a text-to-speech or a USB interface at a peripheral display port.

### DETAILED DESCRIPTION

A text-to-speech dongle couples to a peripheral display of an information handling system to support audible presentation of operating conditions. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

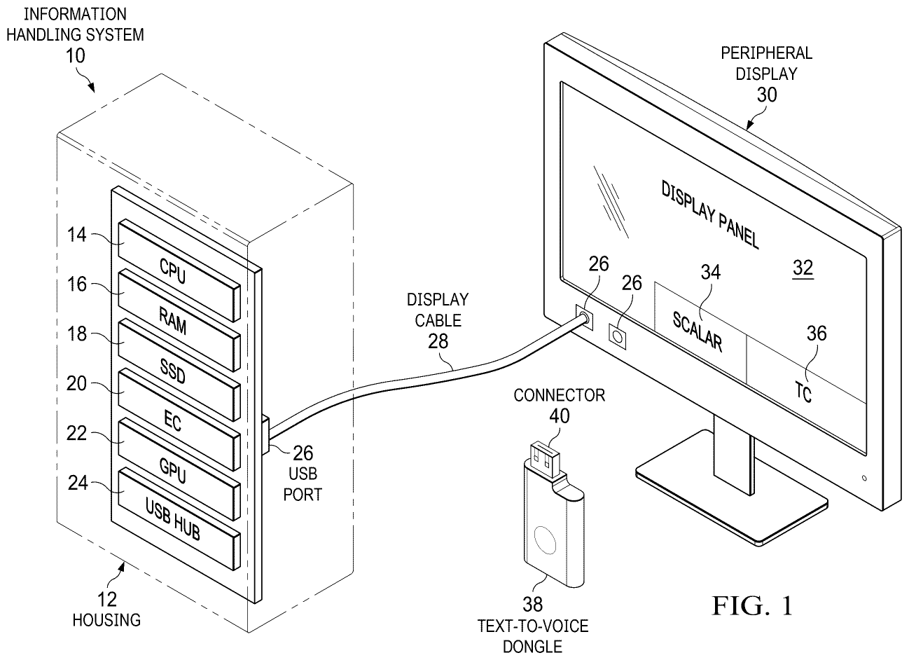

Referring now to FIG. 1, a block diagram depicts an information handling system 10 interfaced with a peripheral display 30 configured to play operational conditions as audible voice from text strings with a text-to-voice dongle 38. Information handling system 10 has a stationary housing 12, such as a desktop or tower configuration, that contains processing components that cooperate to process information. In alternative embodiments, a portable housing may be used, such as a convertible or tablet system. A central processing unit (CPU) 14 executes instructions to process information in cooperation with a random access memory (RAM) 16 that stores the instructions and information. A solid state drive (SSD) 18 provides persistent storage of instructions and information, such as an operating system and applications that are retrieved to RAM at system power up by boot instructions executed on an embedded controller 20, which also manages interactions with peripheral devices, such as a keyboard and mouse. A graphics processing unit (GPU) 22 further processes information to generate visual images for presentation at a display panel, such as by defining an array of pixel values that define colors presented at a display panel's pixels. A USB hub 24 manages communications with external devices through ports 26, such as USB-A, USB-B and USB-C compliant ports. In the example embodiment, port 26 is a Type C port that interfaces through a display cable 28 with peripheral display 30 to present information as visual images. In alternative examples, visual information may be communicated through HDMI, DisplayPort or other types of ports.

Peripheral display 30 is separate from housing 12 and includes a display panel 32 with an array of pixels that present the visual images. Visual information form display cable 28 is accepted at a port 26 and managed by instructions executing on a scalar 34, such as instructions stored in non-transitory memory included in scalar 34 or retrieved to scalar 34 from non-transitory memory coupled to an interface board, such as a SPI flash memory integrated circuit. Scalar 34 has a processing resource that manages operating conditions at display panel 32, such as scaling the resolution and adjusting the image brightness and contrast. Scalar 34 provides visual information to a timing controller 36 that scans the visual image to pixels of display panel 32. Text-to-voice dongle 38 has a connector 40 that inserts into port 26 to interface with scalar 34 and play peripheral display operating conditions as voice, such as in compliance with CVAA requirements. As an example, when first plugged in and detected by scalar 34 text-to-voice dongle 38 plays a voice message that CVAA voice support is available. Other types of voice messages might include the detection of a video source, the lack of a cable connection having a video source, and a power down of peripheral display 30. In the example embodiment, port 26 detects connector 40 to identify when a text-to-voice dongle is connected so that text strings are communicated to the port by the scalar. When a connector couples to the port that is not a text-to-voice dongle, the port operates in a conventional manner, such as by communicating USB-formatted information or whatever format is appropriate for the type of port.

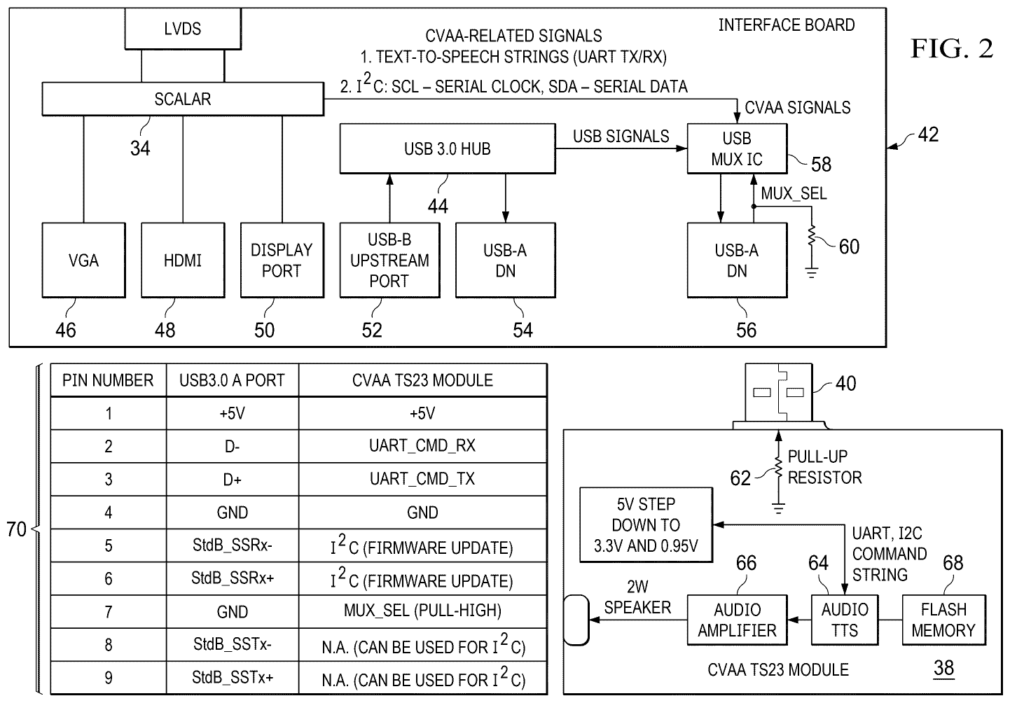

Referring now to FIG. 2, a block diagram depicts an example embodiment of a peripheral display interface board 42 that selectively communicates text formatted information and USB formatted information at a USB port 56. Interface board 42 has a scalar 34 with integrated non-transitory memory and plural display cable ports 46-54. In the example embodiment, the display cable ports include a VGA port 46, an HDMI port 48, a DisplayPort 50, a USB Type B port 52 and a USB Type A port 54. In various embodiments, the USB ports are USB 3.0 compliant and can include Type C ports. Scalar 34 accepts visual information from a display cable, such as from an information handling system, and coordinates presentation of the visual information as visual images with an LVDS interface to a timing controller. USB ports 52 and 54 interface with scalar 34 through a USB hub 44 that coordinates USB-formatted information transfer. For instance, the peripheral display can include support for a mouse or keyboard that couples to the USB ports and communicates from the peripheral display to an information handling system. In some embodiments, the USB hub can support a keyboard, video, mouse interface and network communication or other functionality.

Interface board 42 has one USB-A port 56 that interfaces with both USB hub 44 and scalar 34. When text-to-speech dongle 38 connector 40 couples to USB port 56, the text-to-speech module is identified by opposing pull-up and pull-down resistors so that mux 58 selector interfaces port 56 with scalar 34 instead of USB hub 44. CVAA voice information is communicated from scalar 34 in a UART text string or similar text-formatted information to text-to-speech module 38 for presentation as an audible voice message. When the opposing pull-up and pull-down resistors do not detect a text-to-speech dongle, mux 58 selects an interface of USB hub 44 so that port 56 supports USB formatted information. In the example embodiment, port 56 has a USB-A configuration with pins shown in table 70. Pin 7 is a second ground pin that is used to perform selection of mux 58. Pin 7 at port 56 interfaces with the mux selection input and has a pull-down resistor that drives the selection default to low so that USB hub 44 is selected. Dongle 38 has a pull-up resistor 62 interfaced with pin 7 so that at contact with the pin 7 of port 56 the voltage is pulled high to send a high signal to mux 58 selector input. In response, instructions stored in non-transitory memory or scalar 34 execute to send UART text strings through mux 58, port 56, connector 40 and an audio processing resource 64 that translates the text string to audible voice for presentation by an amplifier and speaker 66. In the example embodiment, the 5V system voltage is stepped down to 3.3V for a high signal and 0.95V for a low signal. In the example embodiment, a flash memory 68 non-transitory memory interfaces with the audio processing resource to store instructions and information to voice output. In another example embodiment, instructions for the scalar to generate the string texts may be stored in flash memory 68 and communicated to the scalar for execution.

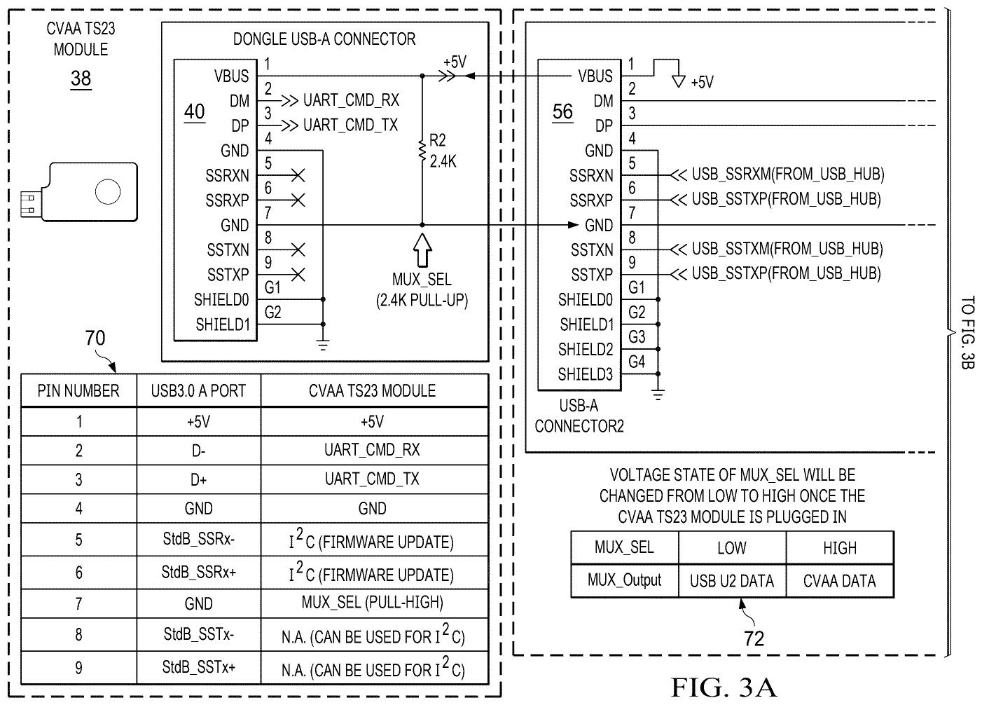

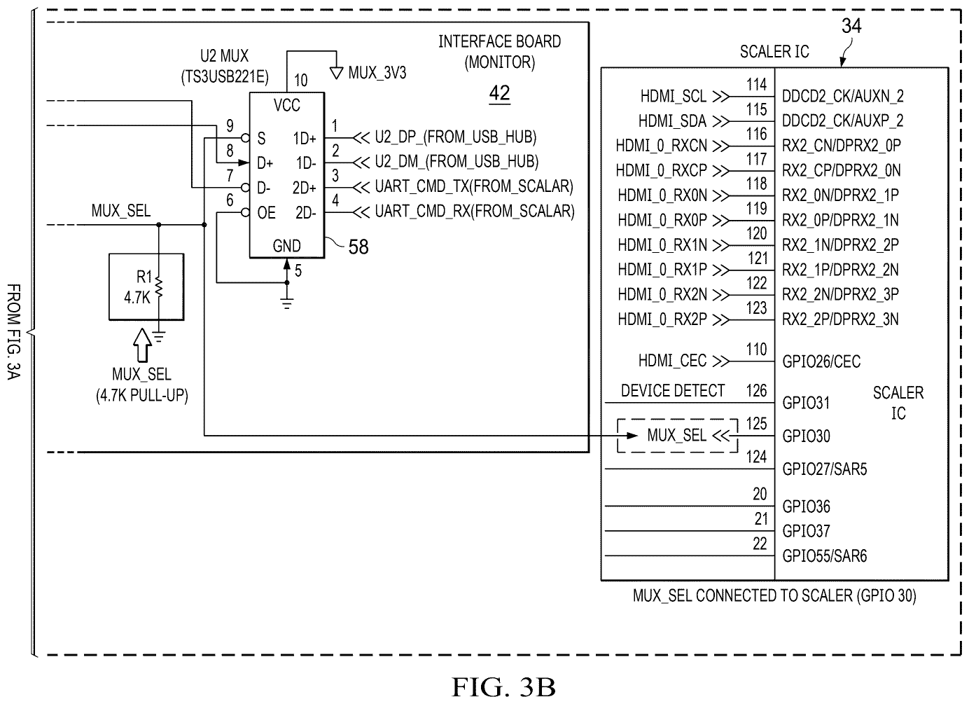

Referring now to FIGS. 3A and 3B, a circuit block diagram depicts communication of CVAA text strings from the scalar to the text-to-speech dongle. In the example embodiment, text-to-voice dongle 38 has a first configuration as a USB 3.0 Type A port 40 with the 9 pins performing the standard USB configuration and a second configuration when pin 7 has a mux opposing resistor pull high to support UART and I2C communication. UART text strings communicate voice information output as audible voice to accommodate CVAA requirements. I2C communication supports firmware updates and other functions, such as communicating instructions to scalar 34. Mux 58 accepts the high or low mux select signal S based upon the interaction through port 56 of the pull-up and pull-down resistors. In the example embodiment a low mux select commands a USB communication mode and a high mux select commands a CVAA mode, as indicated by table 72. In alternative embodiments, the pull-up and pull-down resistors may be reversed. Scalar 34 receives the mux select signal to enable and disable text string for CVAA compliance when the text to speech dongle is connected. In addition, scalar 34 may apply the mux select signal to set automatic volume attenuation, such as at 30%, when helpful for voice presentation.

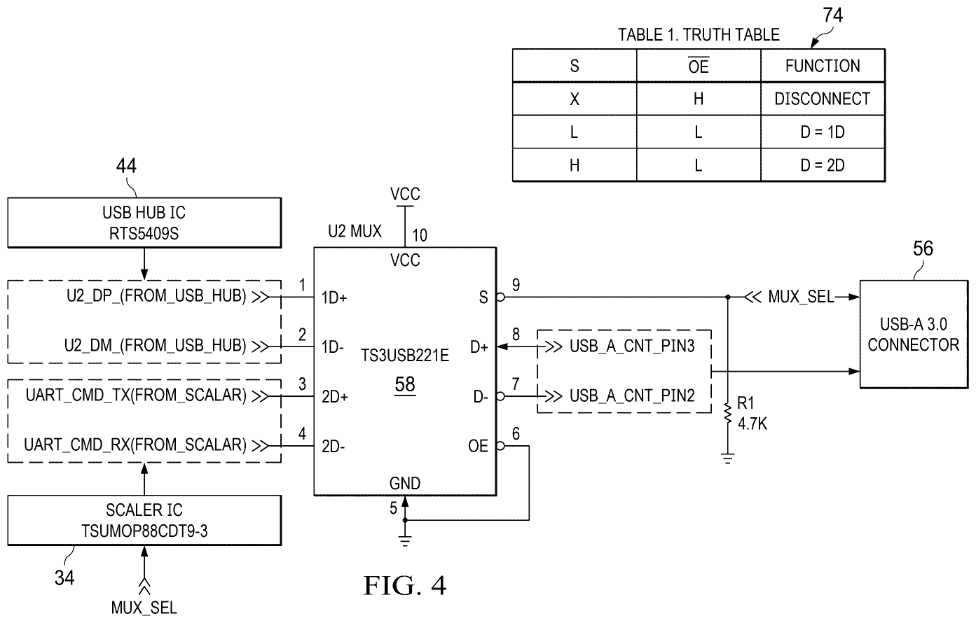

Referring now to FIG. 4, a circuit block diagram depicts one example embodiment of mux 58 communications to support a selected of UART text-formatted information or USB-formatted information. Truth table 74 indicates pin values for each operating mode. When select input S is low, mux 58 interfaces USB hub 44 through the 1D lines. When the select input S is high, mux 58 interfaces scalar 34 through the 2D lines. The mux select value is communicated to scalar 34, such as at a GPIO, so that the scalar knows when text strings of CVAA information are selected to communicate to the text-to-speech dongle.

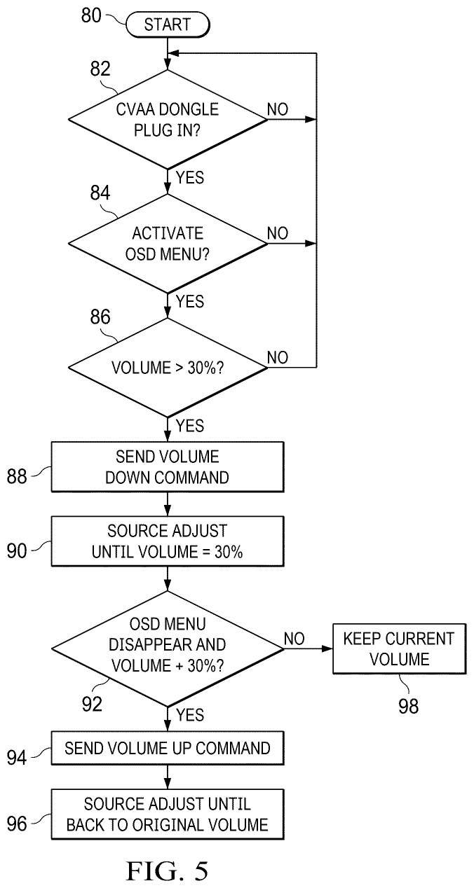

Referring now to FIG. 5, a flow diagram depicts a process for selection of a text-to-speech or a USB interface at a peripheral display port. The process starts at step 80 and at step 82 a determination is made of whether the text-to-speech dongle is connected to the peripheral display USB port. If not the process returns to step 80; if so, the process continues to step 84 to check if the peripheral display on-screen display menu is activated. If the on-screen display menu is presented, a determination is made of whether the volume setting is greater than 30% at step 86. If so the process continues to step 88 to send the volume down command. At step 90 the volume is adjusted to set at 30% or less. At step 92 a determination is made of whether the on-screen display menu is turned off and the volume is at 30%. If not, the volume is kept at the current volume at step 98. If so, the volume up command is sent at step 94 and at step 96 the volume is adjusted to the original volume setting. Automated setting of the volume, such as through the UART interface, helps to ensure that a volume setting is made that will accommodate voice presentations with the text-to-speech dongle volume appropriate to the included speaker capability.

Audio master control is provided from a platform source, such as an information handling system. A display scalar typically sends only volume up and volume down commands. By sending different volume up and down commands through the audio upstream, the end user's set volume is faded into in a tapered manner and without abruptness. This also allows the dongle to automatically adjust to the end user's desired volume should the volume change during the onscreen display menu operation instead of waiting for the menu to disappear.

Although the present invention has been described in detail, it should be understood that various changes, substitutions and alterations can be made hereto without departing from the spirit and scope of the invention as defined by the appended claims.

What is claimed is:

1. An information handling system comprising:
a housing;
a processor coupled in the housing and operable to execute instructions to process information;
a memory coupled in the housing and interfaced with the processor, the memory operable to store the instructions and information;
a peripheral display separate from the housing and interfaced with the processor, the peripheral display operable to present the information as visual images, the peripheral display having an interface board with a scalar, a non-transitory memory and plural ports interfaced with the scalar including at least one USB port having a first configuration that communicates USB-formatted information and a second configuration that communicates text-formatted information;
a dongle having a USB port connector operable to couple to the at least one USB port, a text-to-speech audio processing resource operable to translate text-formatted information to audio and a speaker operable to play the audio; and
instructions stored in the non-transitory memory that when executed on the scalar cause:
identification of the dongle when the dongle connector couples to the at least one USB port; and
communication of display operation instructions as text-formatted information played as audio by the text-to-speech audio processing resource.

2. The information handling system of claim 1 further comprising:
a USB hub interfaced with the plural ports, and the scalar; and
a mux interfaced with the at least one USB port, the scalar and the USB hub, the mux selectively directing the text-formatted information to the at least one USB port when connected to the dongle and otherwise directing USB-formatted information to the at least one USB port.

3. The information handling system of claim 2 wherein the text-formatted information comprises universal asynchronous receiver transmitter (UART) information.

4. The information handling system of claim 3 wherein the instructions include at least a UART text string communicated from the scalar through the mux and to the text-to-speech audio processing resource to generate audio of the text string.

5. The information handling system of claim 4 wherein the text string voices out error messages commanded from the scalar when the processor is not interfaced with the peripheral display.

6. The information handling system of claim 5 wherein the error message describes no cable connection with a video source.

7. The information handling system of claim 5 wherein the error message describes a power off commanded at the peripheral display.

8. The information handling system of claim 2 further comprising:
a pull-up resistor coupled to one of plural ground pins of the dongle USB connector;
a pull-down resistor coupled to one ground of the at least one USB port that corresponds to the one of the plural ground pins of the dongle USB connector; and
a mux select coupled to the pull-down resistor, the mux select having a low voltage when the dongle is not connected and having a high voltage when the dongle is connected.

9. The information handling system of claim 8 further comprising an interface between the mux select and a GPIO of the scalar.

10. A method for presenting audible information at a peripheral display, the method comprising:
identifying a text-to-voice audible dongle connector inserted into a peripheral display port;
in response to the identifying, communicating text strings from a scalar of the peripheral display as text formatted information from the peripheral display port to the peripheral display connector; and
playing the text strings as audible speech at a speaker of the dongle.

11. The method of claim 10 further comprising:
interfacing the peripheral display port with a mux;
interfacing the mux with a USB communication hub and the scalar;
selecting the USB communication hub to communicate USB-formatted information through the mux and to the peripheral display port unless the text-to-voice audible dongle is connected to the peripheral display port; and
selecting the scalar to communicate text-formatted information when the dongle connects to the peripheral display port.

12. The method of claim 11 further comprising:
detecting the dongle with opposing pull-up and pull-down resistor coupled to one ground pin of the port and an opposing ground pin of the connector.

13. The method of claim 12 further comprising:
generating the text string at the scalar in response to an operating condition of the peripheral display; and
communicating the text string as a UART text string.

14. The method of claim 13 wherein the operating condition comprises initial contact of the dongle at the port and the text string describes availability of voice messages.

15. The method of claim 13 wherein the operating condition comprises a power down of the peripheral display and the text string describes power down before the power down is performed.

16. The method of claim 13 wherein the operating condition comprises no video source cable interfaced with the peripheral display and the text string describes no video source.

17. A peripheral display comprising:
an interface board;
a scalar coupled to the interface board;
a non-transitory memory coupled to the interface board;
plural ports coupled to the interface board and interfaced with the scalar including at least one USB port having a first configuration that communicates USB-formatted information and a second configuration that communicates text-formatted information;
a dongle having a USB port connector operable to couple to the at least one USB port, a text-to-speech audio processing resource operable to translate text-formatted information to audio and a speaker operable to play the audio; and
instructions stored in the non-transitory memory that when executed on the scalar cause:
identification of the dongle when the dongle connector couples to the at least one USB port; and
communication of display operation instructions as text-formatted information played as audio by the text-to-speech audio processing resource.

18. The peripheral display of claim 17 further comprising:
a USB hub interfaced with the plural ports, and the scalar; and
a mux interfaced with the at least one USB port, the scalar and the USB hub, the mux selectively directing the text-formatted information to the at least one USB port when connected to the dongle and otherwise directing USB-formatted information to the at least one USB port.

19. The peripheral display of claim 18 further comprising:
a pull-up resistor coupled to one of plural ground pins of the dongle USB connector;
a pull-down resistor coupled to one ground of the at least one USB port that corresponds to the one of the plural ground pins of the dongle USB connector; and
a mux select coupled to the pull-down resistor, the mux select having a low voltage when the dongle is not connected and having a high voltage when the dongle is connected.

20. The peripheral display of claim 19 wherein the text-formatted information comprises universal asynchronous receiver transmitter (UART) information that communicates word strings played as audio at the speaker.
